(19) United States
(12) Patent Application Publication
(10) Pub. No.: US 2025/0345774 A1
(43) Pub. Date: Nov. 13, 2025

(54) SORBENT DEVICES AND METHOD OF MAKING

(71) Applicant: CALGON CARBON CORPORATION, Moon Township, PA (US)

(72) Inventor: Walter G. TRAMPOSCH, Moon Township, PA (US)

(73) Assignee: CALGON CARBON CORPORATION, Moon Township, PA (US)

(21) Appl. No.: 19/099,895

(22) PCT Filed: Aug. 1, 2023
(86) PCT No.: PCT/US2023/071459

§ 371 Date: Jan. 30, 2025

Related U.S. Application Data
(60) Provisional application No. 63/370,177, filed on Aug. 2, 2022.

(51) Int. Cl. B01J 20/28; B01D 53/04; B01J 20/32

(52) U.S. Cl. CPC B01J 20/28035; B01D 53/04; B01J 20/2803; B01J 20/321; B01J 20/3212; B01J 20/3223; B01J 20/3297; B01D 2253/25; B01D 2257/708

(57) ABSTRACT

Sorbent materials for the adsorption of hydrocarbons and methods for manufacturing them are described. The sorbents include a slurry of activated carbon and a porous sheet layer permeable to hydrocarbons configured to remove emissions from air intakes. The methods for manufacturing the sorbent materials include providing both a hydrocarbon permeable layer and a slurry that includes the sorbent material, drying the slurry, and affixing the dried slurry layer to the surface of the hydrocarbon permeable layer.

### CROSS-REFERENCE TO RELATED APPLICATIONS

This application claims benefit of and priority to U.S. Provisional Patent Application No. 63/370,177 titled “Sorbent Devices and Method of Making” filed Aug. 2, 2022, the disclosure of which is incorporated by reference herein in its entirety.

### BACKGROUND

Hydrocarbons are emitted from vehicles in several ways, including, but not limited to, emissions of vapors present in the fuel tank during fueling and emissions from and through the air inlet of the engine. When exposed to sunlight, the hydrocarbons can form photochemical smog and cause negative health effects on humans and animals. Additionally, these emissions cause negative environmental effects through the introduction of greenhouse gases into the atmosphere. As a result of the negative effects of hydrocarbon emissions, the EPA has increased restrictions on hydrocarbon emissions from vehicles.

The hydrocarbon vapors are typically recovered from vehicles by an Onboard Refueling Vapor Recovery system. These systems allow for the recovery of vapors during refueling and the release of the vapors for use in the engine during engine operation. However, these systems are heavy, bulky, and difficult to manufacture.

There exists a need for improved technologies in the removal of hydrocarbons from multiple sources of emissions associated with vehicle engines, gas tanks, and other sources.

### BRIEF DESCRIPTION OF THE DRAWINGS

FIG. 1A illustrates a vapor adsorbing device with a single permeable layer in accordance with an embodiment.

FIG. 1B illustrates a sandwich vapor adsorbing device in accordance with an embodiment.

FIG. 1C illustrates a multilayer vapor adsorbing device in accordance with an embodiment.

FIG. 2A illustrates a vapor adsorbing device with a single permeable layer in accordance with an embodiment.

FIG. 2B illustrates a sandwich vapor adsorbing device in accordance with an embodiment.

FIG. 2C illustrates a multilayer vapor adsorbing device in accordance with an embodiment.

FIG. 3 depicts a diagram of a method of manufacturing a sorbent device in accordance with an embodiment.

FIG. 4 depicts a diagram of a method of manufacturing a sorbent device in accordance with an embodiment.

### SUMMARY

In some embodiments, the techniques described herein relate to a vapor adsorbing device including: one or more dried slurry layers including a sorbent material; and, a first layer permeable to hydrocarbons.

In some embodiments, the techniques described herein relate to a vapor adsorbing device, wherein the sorbent material includes a material selected from the group consisting of activated carbon, reactivated carbon, carbon nanotubes, graphenes, natural and synthetic zeolite, silica, silica gel, alumina, zirconia, and diatomaceous earths, and combinations thereof.

In some embodiments, the techniques described herein relate to a vapor adsorbing device, wherein the first layer includes polypropylene, polyethylene, nylon, or paper.

In some embodiments, the techniques described herein relate to a vapor adsorbing device, wherein the one or more dried slurry layers further include a binder.

In some aspects, the techniques described herein relate to a vapor adsorbing device, wherein the binder includes methylcellulose, poly alcohols, polytetrafluoroethylenes (PTFE or TEFLON), polyvinylidene fluorides (PVF2 or PVDF), ethylene-propylene-diene (EPDM) rubbers, polyethylene oxides (PEO), UV curable acrylates, UV curable methacrylates, heat curable divinyl ethers, polybutylene terephthalate, acetal or polyoxymethylene resin, fluoroelastomers such as perfluoroelastomers (FFKM) and tetrafluoro ethylene/propylene rubbers (FEPM), aramid polymers such as para-aramid and meta-aramid polymers, poly trimethylene terephthalate, ethylene acrylic elastomers, polyimide, polyamide-imides, polyurethanes, low density and high density polyethylene, polypropylene, biaxially oriented polypropylene (BoPP), polyethylene terephthalate (PET), biaxially oriented polyethylene terephthalate (BoPET), polychloroprene, and copolymers and combinations thereof.

In some embodiments, the techniques described herein relate to a vapor adsorbing device, further including a cover layer, wherein the cover layer is configured so each of the one or more dried slurry layers is positioned between the cover layer and the first layer.

In some embodiments, the techniques described herein relate to a vapor adsorbing device, wherein the cover layer is permeable to hydrocarbons.

In some embodiments, the techniques described herein relate to a vapor adsorbing device, wherein the cover layer is including polypropylene, polyethylene, nylon, or paper.

In some embodiments, the techniques described herein relate to a vapor adsorbing device, wherein the cover layer is not permeable to hydrocarbons.

In some embodiments, the techniques described herein relate to a vapor adsorbing device, further including one or more intermediate hydrocarbon permeable layers, wherein each of the one or more intermediate hydrocarbon permeable layers is permeable to hydrocarbons.

In some embodiments, the techniques described herein relate to a vapor adsorbing device, wherein the one or more intermediate hydrocarbon permeable layers are positioned between the one or more dried slurry layers.

In some embodiments, the techniques described herein relate to a vapor adsorbing device, further including one or more adhesive layers.

In some embodiments, the techniques described herein relate to a vapor adsorbing device, wherein each of the one or more adhesive layers are included of a pressure sensitive glue or a hot melt glue.

In some embodiments, the techniques described herein relate to a method of making a sorbent device including: providing a slurry including a sorbent material; providing a first layer permeable to hydrocarbons; applying the slurry to a surface of the first layer to create a top slurry layer; drying the slurry to create a dried slurry layer; and affixing the dried slurry layer to the surface of the first layer.

In some embodiments, the techniques described herein relate to a method, wherein the slurry is provided in an aqueous medium.

In some embodiments, the techniques described herein relate to a method, wherein the slurry is provided in a non-aqueous medium.

In some embodiments, the techniques described herein relate to a method, wherein the slurry is applied by one of spraying, ink jetting, doctor blade coating, dip coating, brushing, roll coating, spin coating, slot die coating, solution casting, flow coating, or calendering.

In some embodiments, the techniques described herein relate to a method, wherein the slurry further includes a binder.

In some embodiments, the techniques described herein relate to a method, wherein the dried slurry layer is affixed to the first layer by the binder.

In some embodiments, the techniques described herein relate to a method, further including providing a first adhesive layer and applying the first adhesive layer to a surface of the first layer prior to applying the slurry to the surface of the first layer.

In some embodiments, the techniques described herein relate to a method, wherein the dried slurry layer is affixed to the surface of the first layer using the adhesive.

In some aspects, the techniques described herein relate to a method, further including: providing one or more intermediate hydrocarbon permeable layers, wherein for each of the one or more intermediate hydrocarbon permeable layers the method includes; applying a top adhesive layer to a top surface of the intermediate hydrocarbon permeable layer; applying a bottom adhesive layer to a bottom surface of the intermediate hydrocarbon permeable layer; applying the bottom adhesive layer to the top slurry layer to sandwich the slurry; applying a slurry to the top adhesive layer to sandwich the intermediate hydrocarbon permeable layer and to create a new top slurry layer; and affixing the one or more intermediate hydrocarbon permeable layers to the dried slurry layers.

In some embodiments, the techniques described herein relate to a method, further including: providing a cover layer; applying a second adhesive layer to a surface of the cover layer; applying the second adhesive layer to the top slurry layer to sandwich the top slurry layer; and affixing the cover layer to the dried slurry layer.

### DETAILED DESCRIPTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention, which will be limited only by the appended claims. Unless defined otherwise, all technical and scientific terms used herein have the same meaning as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

It must also be noted that as used herein and in the appended claims, the singular forms “a,” “an,” and “the” include plural reference unless the context clearly dictates otherwise. Thus, for example, reference to “a sorbent material” is a reference to “one or more sorbent materials” and equivalents thereof known to those skilled in the art, and so forth.

As used herein, the term “about” means plus or minus 10% of the numerical value of the number with which it is being used. Therefore, about 50% means in the range of 45%-55%.

As used herein, the term “sorbent material” is meant to encompass all known materials from any source that are capable of absorbing or adsorbing liquids and/or gases. For example, sorbent materials include, but are not limited to, carbonaceous materials such as activated carbon, reactivated carbon, carbon nanotubes, or graphenes. Other sorbent materials that are not carbonaceous materials include natural and synthetic zeolite, silica, silica gel, alumina, zirconia, and diatomaceous earths. In a certain embodiment the sorbent material is activated carbon.

As used herein, the term “dried slurry” means the remaining solid material after the liquid medium from a slurry has been removed. For example, dried slurries include, but are not limited to sorbent materials and binders present in the sorbent materials.

Embodiments are directed towards a vapor adsorbing device comprising one or more dried slurry layers comprising a sorbent material and a first layer permeable to hydrocarbons.

The slurry includes a solid material, including a sorbent material, and a liquid medium. In some embodiments, the liquid medium is an aqueous medium. In some embodiments, the liquid medium a non-aqueous medium.

The amount of solid material in the slurry may be about 50%, about 55%, about 60%, about 65%, about 70%, about 75%, about 80%, about 85%, about 90%, or any individual amount encompassed by these values.

In some embodiments, the sorbent material comprises a carbonaceous material selected from the group consisting of activated carbon, reactivated carbon, carbon nanotubes, and graphenes. The carbonaceous material can be formed from bituminous coal, sub-bituminous coal, lignite coal, anthracite coal, wood, wood chips, sawdust, peat, nut shells, pits, coconut shell, babassu nut, macadamia nut, dende nut, peach pit, cherry pit, olive pit, walnut shell, wood, lignin, polymers, nitrogen-containing polymers, resins, petroleum pitches, bagasse, rice hulls, corn husks, wheat hulls and chaff, graphenes, carbon nanotubes, or polymer fibers. In some embodiments, the sorbent material is selected from the group consisting of natural and synthetic zeolite, silica, silica gel, alumina, zirconia, and diatomaceous earths, and combinations thereof.

In some embodiments, each of the one or more dried slurry layers further comprises a binder configured to adhere the sorbent material to any adjacent hydrocarbon permeable layer, including but not limited to the first layer. In some embodiments, the binder comprises methylcellulose, poly alcohols, polytetrafluoroethylenes (PTFE or TEFLON), polyvinylidene fluorides (PVF₂ or PVDF), ethylene-propylene-diene (EPDM) rubbers, polyethylene oxides (PEO), UV curable acrylates, UV curable methacrylates, heat curable divinyl ethers, polybutylene terephthalate, acetal or polyoxymethylene resin, fluoroelastomers such as perfluoroelastomers (FFKM) and tetrafluoro ethylene/propylene rubbers (FEPM), aramid polymers such as para-aramid and meta-aramid polymers, poly trimethylene terephthalate, ethylene acrylic elastomers, polyimide, polyamide-imides, polyurethanes, low density and high density polyethylene, polypropylene, biaxially oriented polypropylene (BoPP), polyethylene terephthalate (PET), biaxially oriented polyethylene terephthalate (BoPET), polychloroprene, and copolymers and combinations thereof.

In some embodiments, each of the one or more dried slurry layers can have a thickness of about 3 mm, about 2.8 mm, about 2.6 mm, about 2.4 mm, about 2.2 mm, about 2.0 mm, about 1.8 mm, about 1.6 mm, about 1.4 mm, about 1.2 mm, about 1.0 mm, about 0.8 mm, about 0.6 mm, about 0.4 mm, about 0.2 mm, about 0.1 mm, about 0.05 mm, about 0.01 mm, or any individual thickness encompassed by these values.

In some embodiments, the first layer is porous. The first layer may comprise but is not limited to polypropylene, polyethylene, nylon, paper, or other hydrocarbon permeable materials. In some embodiments, the first layer can have a thickness of about 3 mm, about 2.8 mm, about 2.6 mm, about 2.4 mm, about 2.2 mm, about 2.0 mm, about 1.8 mm, about 1.6 mm, about 1.4 mm, about 1.2 mm, about 1.0 mm, about 0.8 mm, about 0.6 mm, about 0.4 mm, about 0.2 mm, about 0.1 mm, about 0.05 mm, about 0.01 mm, or any individual thickness encompassed by these values.

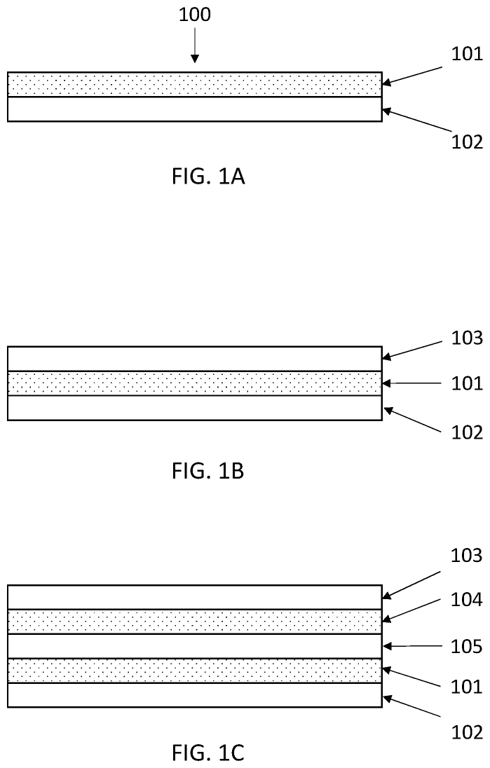

FIG. 1A illustrates a vapor adsorbing device 100 comprising a dried slurry layer 101 comprising a sorbent material and a binder and a first hydrocarbon permeable layer 102. The dried slurry layer 101 is affixed to the first hydrocarbon permeable layer 102 by the binder in the dried slurry layer 101.

In some embodiments, see FIG. 1B the vapor adsorbing device 100 further comprises a cover layer 103 affixed to the dried slurry layer 101. The cover layer 103 is configured so that the dried slurry layer 101 is positioned between the cover layer 103 and the first hydrocarbon permeable layer 102, so that the dried slurry layer 101 is sandwiched between the cover layer 103 and the first hydrocarbon permeable layer 102. In some embodiments, the cover layer 103 is affixed to the dried slurry layer 101 opposite the first hydrocarbon permeable layer 102 by the binder. In some embodiments the cover layer 103 is permeable to hydrocarbons. The cover layer 103 may be the same as or different from the first hydrocarbon permeable layer 102. The cover layer 103 may comprise but is not limited to polytetrafluoroethylenes (PTFE or TEFLON), polyvinylidene fluorides (PVF₂ or PVDF), ethylene-propylene-diene (EPDM) rubbers, polyethylene oxides (PEO), UV curable acrylates, UV curable methacrylates, heat curable divinyl ethers, polybutylene terephthalate, acetal or polyoxymethylene resin, fluoroelastomers such as perfluoroelastomers (FFKM) and tetrafluoro ethylene/propylene rubbers (FEPM), aramid polymers such as para-aramid and meta-aramid polymers, poly trimethylene terephthalate, ethylene acrylic elastomers, polyimide, polyamide-imides, polyurethanes, low density and high density polyethylene, polypropylene, biaxially oriented polypropylene (BoPP), polyethylene terephthalate (PET), biaxially oriented polyethylene terephthalate (BoPET), polychloroprene, nylon, paper, and copolymers and combinations thereof. In some embodiments, the cover layer is not permeable to hydrocarbons.

In some embodiments, the cover layer 103 can have a thickness of about 3 mm, about 2.8 mm, about 2.6 mm, about 2.4 mm, about 2.2 mm, about 2.0 mm, about 1.8 mm, about 1.6 mm, about 1.4 mm, about 1.2 mm, about 1.0 mm, about 0.8 mm, about 0.6 mm, about 0.4 mm, about 0.2 mm, about 0.1 mm, about 0.05 mm, about 0.01 mm, or any individual thickness encompassed by these values.

FIG. 1B illustrates a vapor adsorbing device comprising a dried slurry layer 101 comprising a sorbent material and a binder, a first hydrocarbon permeable layer 102, and a cover layer 103. In some embodiments, the cover layer 103 is configured to be permeable to hydrocarbons. The dried slurry layer 101 is affixed to the first hydrocarbon permeable layer 102 and cover layer 103 by the binder in the dried slurry layer 101.

In some embodiments, the vapor adsorbing device further comprises one or more intermediate dried slurry layers 104. Such intermediate dried slurry layers 104, may be the same or different from other dried slurry layers (e.g. 101 or additional dried slurry layers 104), and are arranged such that successive dried slurry layers are separated by an intermediate hydrocarbon permeable layer 105 that may be the same as or different from the first hydrocarbon permeable layer 102. In some embodiments, a cover layer 103, comprising a hydrocarbon permeable layer maybe provided. In other embodiments (not shown), the uppermost dried slurry layer 104 is left without a cover layer. In some embodiments, each of the one or more intermediate hydrocarbon permeable layers may comprise but is not limited to polytetrafluoroethylenes (PTFE or TEFLON), polyvinylidene fluorides (PVF₂ or PVDF), ethylene-propylene-diene (EPDM) rubbers, polyethylene oxides (PEO), UV curable acrylates, UV curable methacrylates, heat curable divinyl ethers, polybutylene terephthalate, acetal or polyoxymethylene resin, fluoroelastomers such as perfluoroelastomers (FFKM) and tetrafluoro ethylene/propylene rubbers (FEPM), aramid polymers such as para-aramid and meta-aramid polymers, poly trimethylene terephthalate, ethylene acrylic elastomers, polyimide, polyamide-imides, polyurethanes, low density and high density polyethylene, polypropylene, biaxially oriented polypropylene (BoPP), polyethylene terephthalate (PET), biaxially oriented polyethylene terephthalate (BoPET), polychloroprene, nylon, paper, and copolymers and combinations thereof.

In some embodiments, each of the one or more intermediate hydrocarbon permeable layers can have a thickness of about 3 mm, about 2.8 mm, about 2.6 mm, about 2.4 mm, about 2.2 mm, about 2.0 mm, about 1.8 mm, about 1.6 mm, about 1.4 mm, about 1.2 mm, about 1.0 mm, about 0.8 mm, about 0.6 mm, about 0.4 mm, about 0.2 mm, about 0.1 mm, about 0.05 mm, about 0.01 mm, or any individual thickness encompassed by these values. The vapor adsorbing device can generally comprise any number of intermediate layers. For example, the number of the each of the one or more intermediate layers can be 1, 2, 3, 4, 5, or 6.

FIG. 1C illustrates a vapor adsorbing device comprising a cover layer 103, a dried slurry layer 101 comprising a sorbent material and a binder, an intermediate hydrocarbon permeable layer 105, a second dried slurry layer 104 comprising a sorbent material and a binder, and a first hydrocarbon permeable layer 102. The (optional) cover layer 103 is affixed to the second dried slurry layer 104 by the binder in the second dried slurry layer 104. The intermediate hydrocarbon permeable layer 105 is affixed to each adjacent dried slurry layers 101, 104 by the binder in the dried slurry layers. The intermediate hydrocarbon permeable layer 105 is affixed to the dried slurry layer 101 by the binder in the dried slurry layer 101.

The number of intermediate slurry and hydrocarbon permeable layers is not limited. Each successive dried slurry layer is separated by the previous dried slurry layer by a hydrocarbon permeable layer. The last dried slurry layer may be left exposed or capped with a cover layer.

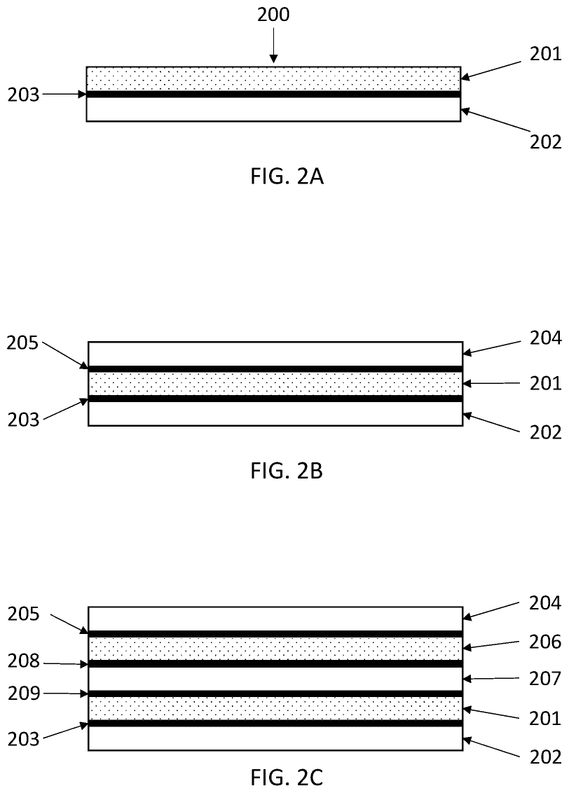

In some embodiments, e.g., FIGS. 2A, 2B, and 2C, the vapor adsorbing device further comprises one or more adhesive layers. In some embodiments, each of the one or more adhesive layers are a pressure sensitive glue or a hot melt glue. In some embodiments, the one or more adhesive layers are configured to affix the one or more dried slurry layers to each of the other layers including the first hydrocarbon permeable layer, the cover layer, and the one or more intermediate hydrocarbon permeable layers. In some embodiments, the one or more adhesive layers are positioned between the one or more dried slurry layers and each of the other layers including the first hydrocarbon permeable layer, the cover layer, and the one or more intermediate hydrocarbon permeable layers.

In some embodiments, each of the one or more adhesive layers can have a thickness of about 0.1 mm, about 0.09 mm, about 0.08 mm, about 0.07 mm, about 0.06 mm, about 0.05 mm, about 0.04 mm, about 0.03 mm, about 0.02 mm, about 0.01 mm, or any individual thickness encompassed by these values.

FIG. 2A illustrates a vapor adsorbing device 200 comprising a dried slurry layer 201 comprising a sorbent material, a first hydrocarbon permeable layer 202, and an adhesive layer 203 between the dried slurry layer 201 and the first hydrocarbon permeable layer 202. The adhesive layer 203 is configured to affix the dried slurry layer 201 to the first hydrocarbon permeable layer 202.

FIG. 2B illustrates a vapor adsorbing device comprising a cover layer 204, a dried slurry layer 201 comprising a sorbent material, a first hydrocarbon permeable layer 202, a first adhesive layer 205 positioned between the cover layer 204 and dried slurry layer 201, and an adhesive layer 203 positioned between the dried slurry layer 201 and first hydrocarbon permeable layer 202. The first adhesive layer 205 is configured to affix the cover layer 204 to the dried slurry layer 201. The adhesive layer 203 is configured to affix the dried slurry layer 201 to the first hydrocarbon permeable layer 202.

FIG. 2C. illustrates a vapor adsorbing device comprising a cover layer 204, a first dried slurry layer 206, an intermediate hydrocarbon permeable layer 207, a dried slurry layer 201, and a first hydrocarbon permeable layer 202. The vapor adsorbing device further comprises a first adhesive layer 205 positioned between the cover layer 204 and the first dried slurry layer 206 configured to adhere the cover layer 204 to the first dried slurry layer 206. The vapor adsorbing device further comprises a second adhesive layer 208 positioned between the intermediate hydrocarbon permeable layer 207 and the first dried slurry layer 206 configured to adhere the intermediate hydrocarbon permeable layer 207 to the first dried slurry layer 206. The vapor adsorbing device further comprises a third adhesive layer 209 positioned between the intermediate hydrocarbon permeable layer 207 and the dried slurry layer 201 configured to adhere the intermediate hydrocarbon permeable layer 207 to the dried slurry layer 201. The vapor adsorbing device further comprises an adhesive layer 203 positioned between the first hydrocarbon permeable layer 202 and the dried slurry layer 201 configured to adhere the first hydrocarbon permeable layer 202 to the dried slurry layer 201.

Embodiments are directed towards a method of making a sorbent device comprising providing a slurry comprising a sorbent material, providing a first layer permeable to hydrocarbons, applying the slurry to a surface of the first layer, drying the slurry to create a dried slurry layer, and affixing the dried slurry layer to the surface of the first layer.

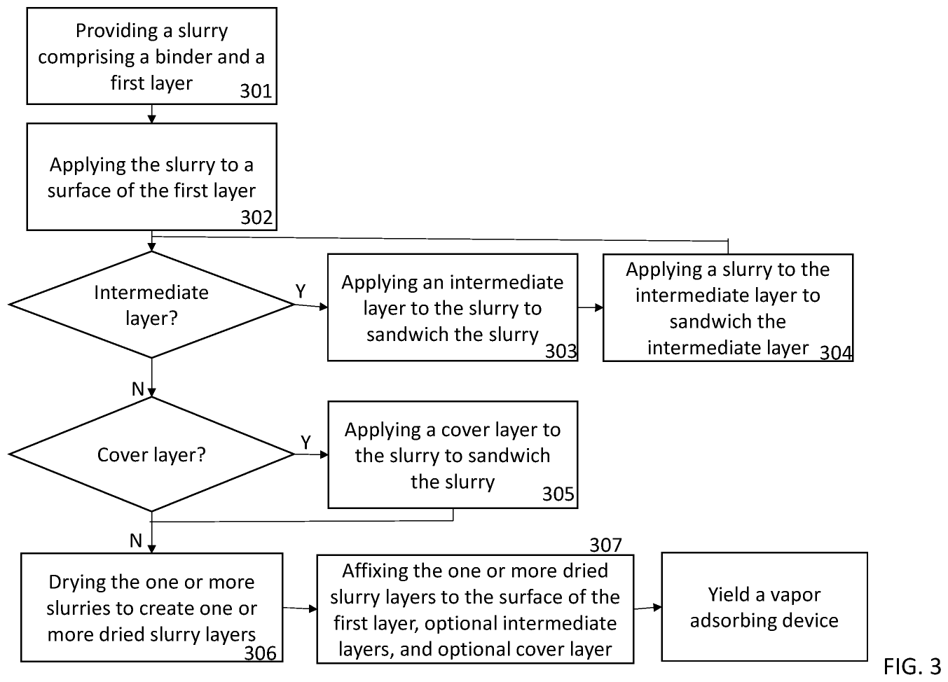

FIG. 3 illustrates a diagram for manufacturing a vapor adsorbing device. The method comprises providing 301 a slurry comprising a binder and a first hydrocarbon permeable layer and first applying 302 the slurry to a surface of the first hydrocarbon permeable layer. The slurry can be applied 302 to the surface of the first hydrocarbon permeable layer by any known method. In some embodiments, the slurry is applied 302 by one of s spraying, ink jetting, doctor blade coating, dip coating, brushing, roll coating, spin coating, slot die coating, solution casting, flow coating, or calendering.

In some embodiments, the method further comprises applying 303 an intermediate hydrocarbon permeable layer to the slurry to sandwich the slurry and applying 304 a slurry to a surface of the intermediate hydrocarbon permeable layer to sandwich the intermediate hydrocarbon permeable layer. The slurry can be applied 304 to the surface of the intermediate hydrocarbon permeable layer by any known method. In some embodiments, the slurry is applied 304 by one or more of spraying, ink jetting, doctor blade coating, dip coating, brushing, roll coating, spin coating, slot die coating, solution casting, flow coating, or calendering. In some embodiments, more than one intermediate hydrocarbon permeable layer is required, and the method further comprises repeating the applying 303 of an intermediate hydrocarbon permeable layer to the slurry and the applying 304 of a slurry to a surface of the intermediate hydrocarbon permeable layer. In some embodiments, the method further comprises applying 305 a cover layer to the slurry to sandwich the slurry.

The method further comprises drying 306 the one or more slurries to create one or more dried slurry layers. The one or more slurries can be dried at ambient temperature and pressure. In some embodiments, heat is applied to the one or more slurries to decrease the time required to dry 306 the one or more slurries. The method further comprises affixing 307 the one or more dried slurry layers to the surface of the first hydrocarbon permeable layer, the optional one or more intermediate hydrocarbon permeable layers, and the optional cover layer. In some embodiments, the one or more dried slurry layers are affixed by the binder in each of the one or more dried slurry layers. In some embodiments, the binder is configured to activate as each of the one or more slurries dry 306.

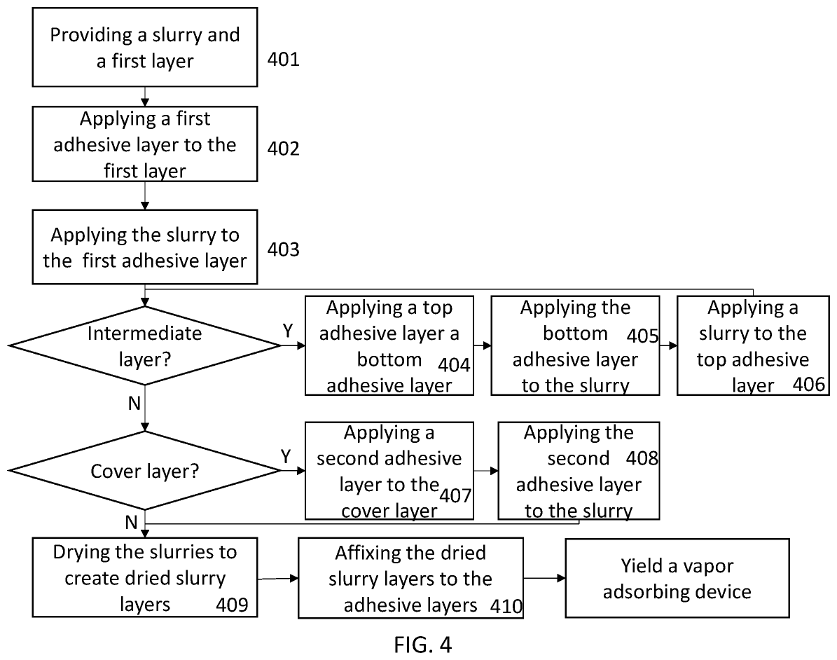

FIG. 4 illustrates a diagram for manufacturing a vapor adsorbing device. The method comprises providing 401 a slurry and a first hydrocarbon permeable layer and applying 402 a first adhesive layer to a surface of the first hydrocarbon permeable layer. In some embodiments, the first adhesive is applied 402 to the entire surface of the first hydrocarbon permeable layer. In some embodiments, the first adhesive is applied 402 to a portion of the first hydrocarbon permeable layer. The method further comprises applying 403 the slurry to the adhesive layer to create a top slurry layer. The slurry can be applied 403 to the adhesive layer by any known method. In some embodiments, the slurry is applied 403 by one of spraying, ink jetting, doctor blade coating, dip coating, brushing, roll coating, spin coating, slot die coating, solution casting, flow coating, or calendering.

In some embodiments, the method further comprises applying 404 a top adhesive layer to a top surface of an intermediate hydrocarbon permeable layer and a bottom adhesive to a bottom surface of the intermediate hydrocarbon permeable layer. In some embodiments, the top adhesive is applied 404 to a portion of the top surface the intermediate hydrocarbon permeable layer. In some embodiments, the top adhesive is applied 404 to the entire top surface the intermediate hydrocarbon permeable layer. In some embodiments, the bottom adhesive is applied 404 to a portion of the bottom surface the intermediate hydrocarbon permeable layer. In some embodiments, the bottom adhesive is applied 404 to the entire bottom surface of the top surface the intermediate hydrocarbon permeable layer.

In some embodiments, the method further comprises applying 405 the bottom adhesive layer to the top slurry layer to sandwich the top slurry layer. In some embodiments, the method further comprises applying 406 a slurry to the top adhesive layer to sandwich the intermediate hydrocarbon permeable layer and to create a new top slurry layer. The slurry can be applied 406 to the top surface of the adhesive layer by any known method. In some embodiments, the slurry is applied 406 by one of spraying, ink jetting, doctor blade coating, dip coating, brushing, roll coating, spin coating, slot die coating, solution casting, flow coating, or calendering. In some embodiments, more than one intermediate hydrocarbon permeable layer is required, and the method further comprises repeating the applying 404 a top adhesive layer to a top surface of an intermediate hydrocarbon permeable layer and a bottom adhesive to a bottom surface of the intermediate hydrocarbon permeable layer, the applying 405 the bottom adhesive layer to the top slurry layer to sandwich the top slurry layer, and the applying 406 a slurry to the top adhesive layer to sandwich the intermediate hydrocarbon permeable layer and to create a new top slurry layer.

In some embodiments, the method further comprises applying 407 a second adhesive layer to a surface a cover layer, and the applying 408 of the second adhesive to the top slurry layer to sandwich the top slurry layer. In some embodiments, the second adhesive is applied 407 to the entire surface the cover layer. In some embodiments, the second adhesive is applied 407 to a portion of the surface the cover layer.

The method further comprises drying 409 the one or more slurries to create one or more dried slurry layers. The one or more slurries can be dried at ambient temperature and pressure. In some embodiments, heat is applied to the one or more slurries to decrease the time required to dry 409 the one or more slurries. The method further comprises affixing 410 the one or more dried slurry layers to the one or more adhesive layers. In some embodiments, the one or more adhesive layers are comprised on pressure-sensitive glue and are affixed 410 to the one or more dried slurry layers by applying pressure to the adhesive.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etcetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A vapor adsorbing device comprising:
a dried slurry layer comprising a sorbent material; and
a first hydrocarbon permeable layer;
wherein the dried slurry layer is affixed to the first hydrocarbon permeable layer.

2. The vapor adsorbing device of claim 1, wherein the sorbent material includes a material selected from the group consisting of activated carbon, reactivated carbon, carbon nanotubes, graphenes, natural and synthetic zeolite, silica, silica gel, alumina, zirconia, and diatomaceous earths, and combinations thereof.

3. The vapor adsorbing device of claim 1, wherein the first hydrocarbon permeable layer comprises polypropylene, polyethylene, nylon, or paper.

4. The vapor adsorbing device of claim 1, wherein the dried slurry layer further comprises a binder.

5. The vapor adsorbing device of claim 4, wherein the binder comprises methylcellulose, poly alcohols, polytetrafluoroethylenes (PTFE or TEFLON), polyvinylidene fluorides (PVF₂ or PVDF), ethylene-propylene-diene (EPDM) rubbers, polyethylene oxides (PEO), UV curable acrylates, UV curable methacrylates, heat curable divinyl ethers, polybutylene terephthalate, acetal or polyoxymethylene resin, fluoroelastomers such as perfluoroelastomers (FFKM) and tetrafluoro ethylene/propylene rubbers (FEPM), aramid polymers such as para-aramid and meta-aramid polymers, poly trimethylene terephthalate, ethylene acrylic elastomers, polyimide, polyamide-imides, polyurethanes, low density and high density polyethylene, polypropylene, biaxially oriented polypropylene (BoPP), polyethylene terephthalate (PET), biaxially oriented polyethylene terephthalate (BoPET), polychloroprene, and copolymers and combinations thereof.

6. The vapor adsorbing device of claim 1, further comprising a cover layer, wherein the cover layer is configured so the dried slurry layer is positioned between the cover layer and the first hydrocarbon permeable layer.

7. The vapor adsorbing device of claim 6, wherein the cover layer is permeable to hydrocarbons.

8. The vapor adsorbing device of claim 7, wherein the cover layer comprises polypropylene, polyethylene, nylon, or paper.

9. The vapor adsorbing device of claim 6, wherein the cover layer is not permeable to hydrocarbons.

10. The vapor adsorbing device of claim 1, further comprising one or more intermediate dried slurry layers, wherein adjacent dried slurry layers are separated by an intermediate hydrocarbon permeable layer.

11. The vapor adsorbing device of claim 10, further comprising an adhesive layer between each adjacent the intermediate hydrocarbon permeable layer and intermediate dried slurry layer.

12. The vapor adsorbing device of claim 10, further comprising a cover layer, such that each of the dried slurry layer, each intermediate dried slurry layer, and each intermediate hydrocarbon permeable layer are sandwiched between the cover layer and the first hydrocarbon permeable layer.

13. The vapor adsorbing device of claim 1, further comprising an adhesive layer between the first hydrocarbon permeable layer and the dried slurry layer.

14. The vapor adsorbing device of claim 13, wherein each of the adhesive layers is comprised of a pressure sensitive glue or a hot melt glue.

15. A method of making a sorbent device comprising:
providing a slurry comprising a sorbent material;
providing a first hydrocarbon permeable layer;
applying the slurry to a surface of the first hydrocarbon permeable layer to create atop slurry layer;
drying the slurry to create a dried slurry layer; and
affixing the dried slurry layer to the surface of the first hydrocarbon permeable layer.

16. The method of claim 15, wherein the slurry is provided in an aqueous medium.

17. The method of claim 15, wherein the slurry is provided in a non-aqueous medium.

18. The method of claim 15, wherein the slurry is applied by one of spraying, ink jetting, doctor blade coating, dip coating, brushing, roll coating, spin coating, slot die coating, solution casting, flow coating, or calendering.

19. The method of claim 15, wherein the slurry further comprises a binder.

20. The method of claim 19, wherein the dried slurry layer is affixed to the first hydrocarbon permeable layer by the binder.

21. The method of claim 15, further comprising providing a first adhesive layer and applying the first adhesive layer to a surface of the first hydrocarbon permeable layer prior to applying the slurry to the surface of the first hydrocarbon permeable layer.

22. The method of claim 21, wherein the dried slurry layer is affixed to the surface of the first hydrocarbon permeable layer using the first adhesive layer.

23. The method of claim 21, further comprising:
providing one or more intermediate hydrocarbon permeable layers, wherein for each of the one or more intermediate hydrocarbon permeable layers the method comprises;
applying a top adhesive layer to a top surface of the intermediate hydrocarbon permeable layer;
applying a bottom adhesive layer to a bottom surface of the intermediate hydrocarbon permeable layer;
applying the bottom adhesive layer to the top slurry layer to sandwich the slurry;
applying a slurry to the top adhesive layer to sandwich the intermediate hydrocarbon permeable layer and to create a new top slurry layer; and
affixing the one or more intermediate hydrocarbon permeable layers to the dried slurry layers.

24. The method of claim 21, further comprising:
providing a cover layer;
applying a second adhesive layer to a surface of the cover layer;
applying the second adhesive layer to the top slurry layer to sandwich the top slurry layer, and
affixing the cover layer to the dried slurry layer.
